(19) United States
(12) Patent Application Publication
(10) Pub. No.: US 2025/0055197 A1
(43) Pub. Date: Feb. 13, 2025

(54) TRANSMISSION LINE, AND ANTENNA MODULE AND COMMUNICATION DEVICE INCLUDING THE SAME

(71) Applicant: Murata Manufacturing Co., Ltd., Nagaokakyo-shi (JP)

(72) Inventor: Yoshiki YAMADA, Nagaokakyo-shi (JP)

(73) Assignee: Murata Manufacturing Co., Ltd., Nagaokakyo-shi (JP)

(21) Appl. No.: 18/931,312

(22) Filed: Oct. 30, 2024

Related U.S. Application Data
(63) Continuation of application No. PCT/JP2023/001125, filed on Jan. 17, 2023.

(30) Foreign Application Priority Data
May 2, 2022 (JP) 2022-075892

(51) Int. Cl. H01Q 13/08; H01Q 21/06

(52) U.S. Cl. CPC H01Q 13/08; H01Q 21/06

(57) ABSTRACT

A transmission line includes a ground electrode, a first line, and a second line, and transfers a radio frequency signal. The first line is disposed to face the ground electrode and constitutes a microstrip line together with the ground electrode. The second line faces the first line and is disposed along the first line. The second line constitutes a resonator for the first line. The first line is disposed between the second line and the ground electrode.

### CROSS-REFERENCE TO RELATED APPLICATIONS

This is a continuation application of PCT/JP2023/001125, filed on Jan. 17, 2023, designating the United States of America, which is based on and claims priority to Japanese Patent Application No. JP 2022-075892 filed on May 2, 2022. The entire contents of the above-identified applications, including the specifications, drawings and claims, are incorporated herein by reference in their entirety.

### TECHNICAL FIELD

The present disclosure relates to a transmission line, and an antenna module and a communication device including the same, and more particularly, to a configuration of a transmission line to lower a signal in a specific frequency band.

### BACKGROUND ART

Japanese Unexamined Patent Application Publication No. 2019-92130 (Patent Document 1) discloses a dual-band type patch antenna in which two radiating conductors having different frequency bands are disposed on a substrate. In the patch antenna disclosed in Japanese Unexamined Patent Application Publication No. 2019-92130 (Patent Document 1), an open stub having one end opened is coupled to a feed conductor coupled to each radiating conductor, and a signal in a frequency band of the other side is blocked by the open stub. This facilitates adjustment of a resonant frequency or impedance of each radiating conductor.

### CITATION LIST

### Patent Document

Patent Document 1: Japanese Unexamined Patent Application Publication No. 2019-92130

### SUMMARY OF DISCLOSURE

### Technical Problem

The open stub in the patch antenna disclosed in Japanese Unexamined Patent Application Publication No. 2019-92130 (Patent Document 1) is disposed so as to extend in a direction perpendicular to an extending direction of the feed conductor in plan view from a normal direction of each radiating conductor. In the case of the configuration above, isolation between the patch antennas may be guaranteed by securing an attenuation amount for a signal in a frequency band to be attenuated. On the other hand, assuming the attenuation amount is large, a frequency band to be allowed to pass through may also be affected. In addition, since a relatively large area on a substrate is required to dispose the stub, it may be a factor that hinders the reduction of the patch antenna in size.

The present disclosure has been made to solve the problem described above, and an object of the present disclosure is to provide a transmission line that may be realized with a small disposition area and that mitigates an excessive attenuation characteristic to suppress deterioration of a bandpass characteristic.

### Solution to Problem

A transmission line according to a first aspect of the present disclosure relates to a transmission line to transfer a radio frequency signal. The transmission line includes a ground electrode, a first line, and a second line. The first line is disposed to face the ground electrode and constitutes a microstrip line together with the ground electrode. The second line faces the first line and is disposed along the first line. The second line constitutes a resonator for the first line. The first line is disposed between the second line and the ground electrode.

An antenna module according to a second aspect of the present disclosure includes a ground electrode, a first radiating electrode, a second radiating electrode, a first feed line, and a second feed line. Each of the first radiating electrode and the second radiating electrode is disposed to face the ground electrode and has a flat planar shape. The first feed line transfers a radio frequency signal to the first radiating electrode. The second feed line transfers a radio frequency signal to the second radiating electrode. The second radiating electrode is disposed between the first radiating electrode and the ground electrode. A size of the second radiating electrode is larger than a size of the first radiating electrode. Each of the first feed line and the second feed line includes a first line and a second line. The first line is disposed to face the ground electrode and constitutes a microstrip line together with the ground electrode. The second line faces the first line and is disposed along the first line. The second line constitutes a resonator for the first line. The first line is disposed between the second line and the ground electrode.

### Advantageous Effects of Disclosure

In the transmission line of the present disclosure, a second line is disposed above a first line constituting a microstrip line together with a ground electrode, and is disposed along the first line. With the configuration above, a configuration with a small disposition area may be made possible, and an excessive attenuation characteristic may be mitigated to suppress deterioration of a bandpass characteristic.

### BRIEF DESCRIPTION OF DRAWINGS

FIG. 1 is a block diagram of a communication device to which an antenna module including a transmission line according to Embodiment 1 is applied.

FIG. 2 is a perspective view of the antenna module in FIG. 1.

FIG. 3 is a side transparent view of the antenna module in FIG. 1.

FIG. 4 is a perspective view for explaining a configuration of the transmission line of Embodiment 1 and a configuration of a transmission line of a comparative example.

FIG. 5 is a diagram for explaining a bandpass characteristic of the transmission lines of Embodiment 1 and the comparative example for 39 GHz frequency band.

FIG. 6 is a diagram for explaining a bandpass characteristic of the transmission lines of Embodiment 1 and the comparative example for 28 GHz frequency band.

FIG. 7 is a diagram for explaining an effect of a distance between a main line and a resonant line on a bandpass characteristic.

FIG. 8 is a diagram for explaining an effect of a line width of a resonant line on a bandpass characteristic.

FIG. 9 is a perspective view illustrating a transmission line of Modification.

FIG. 10 is a diagram illustrating a configuration and a bandpass characteristic of a transmission line according to Embodiment 2.

FIG. 11 is a diagram illustrating a configuration and a bandpass characteristic of a transmission line according to Embodiment 3.

FIG. 12 is a side transparent view illustrating a first modification of the antenna module.

FIG. 13 is a perspective view illustrating a second modification of the antenna module.

### DESCRIPTION OF EMBODIMENTS

Hereinafter, embodiments of the present disclosure will be described in detail with reference to the drawings. In the drawings, the same or corresponding portions are denoted by the same reference signs, and the description thereof will not be repeated.

### Embodiment 1

### (Basic Configuration of Communication Device)

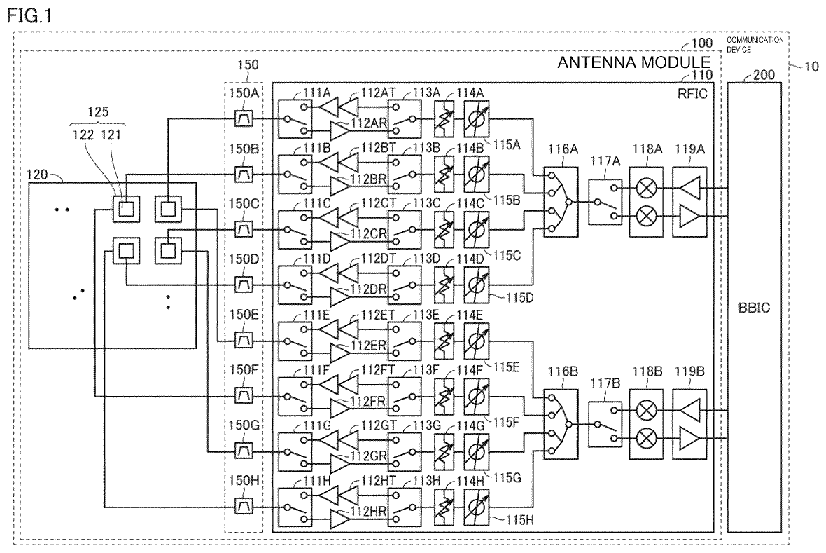

FIG. 1 is an example of a block diagram of a communication device to which an antenna module including a configuration of a transmission line according to Embodiment 1 is applied. A communication device 10 is, for example, a mobile terminal such as a mobile phone, a smartphone, or a tablet, or a personal computer having a communication function. An example of a frequency band of a radio wave used in an antenna module 100 according to the present embodiment is a millimeter wave band radio wave having center frequencies of 28 GHz, 39 GHZ, 60 GHZ, and the like, for example. However, a radio wave in a frequency band other than the above may be used.

Referring to FIG. 1, the communication device 10 includes the antenna module 100 and a BBIC 200 that constitutes a baseband signal processing circuit. The antenna module 100 includes an RFIC 110 which is an example of a feed circuit, an antenna device 120, and a resonant line 150. The communication device 10 up-converts a signal transferred from the BBIC 200 to the antenna module 100 into a radio frequency signal in the RFIC 110, and radiates the radio frequency signal from the antenna device 120 through the resonant line 150. The communication device 10 transmits a radio frequency signal received by the antenna device 120 to the RFIC 110 through the resonant line 150, and down-converts the signal. The down-converted signal is processed in the BBIC 200.

In FIG. 1, to facilitate explanation, a configuration corresponding to four radiating elements 125 among the plurality of radiating elements 125 constituting the antenna device 120 is illustrated, and the configuration corresponding to other radiating elements 125 having the same configuration is omitted. Each of the plurality of radiating elements 125 includes radiating electrodes 121 and 122 having a flat planar shape and capable of radiating radio waves in frequency bands different from each other. That is, the antenna device 120 is a so-called dual-band type antenna device.

Although an example is illustrated in FIG. 1 in which the antenna device 120 is configured of the plurality of radiating elements 125 disposed in a two-dimensional array, the antenna device 120 may be a one-dimensional array in which the plurality of radiating elements 125 are disposed in a line. Alternatively, the antenna device 120 may be configured of a single radiating element 125. In the example of Embodiment 1, the radiating element 125 is a patch antenna having a substantially square flat planar shape.

The RFIC 110 includes switches 111A to 111H, 113A to 113H, 117A, and 117B, power amplifiers 112AT to 112HT, low-noise amplifiers 112AR to 112HR, attenuators 114A to 114H, phase-shifters 115A to 115H, signal combiners/dividers 116A and 116B, mixers 118A and 118B, and amplification circuits 119A and 119B. Among the above, a configuration of the switches 111A to 111D, 113A to 113D, and 117A, the power amplifiers 112AT to 112DT, the low-noise amplifiers 112AR to 112DR, the attenuators 114A to 114D, the phase-shifters 115A to 115D, the signal combiner/divider 116A, the mixer 118A, and the amplification circuit 119A is a circuit for a radio frequency signal to be transferred to the radiating electrode 121. Further, a configuration of the switches 111E to 111H, 113E to 113H, and 117B, the power amplifiers 112ET to 112HT, the low-noise amplifiers 112ER to 112HR, the attenuators 114E to 114H, the phase-shifters 115E to 115H, the signal combiner/divider 116B, the mixer 118B, and the amplification circuit 119B is a circuit for a radio frequency signal to be transferred to the radiating electrode 122.

While transmitting a radio frequency signal, the switches 111A to 111H and 113A to 113H are switched to the power amplifiers 112AT to 112HT side, respectively, and the switches 117A and 117B are switched to the transmission side amplifiers in the amplification circuits 119A and 119B, respectively. While receiving a radio frequency signal, the switches 111A to 111H and 113A to 113H are switched to the low-noise amplifiers 112AR to 112HR side, respectively, and the switches 117A and 117B are switched to the reception side amplifiers in the amplification circuits 119A and 119B, respectively.

Signals transferred from the BBIC 200 are amplified by the amplification circuits 119A and 119B and up-converted by the mixers 118A and 118B, respectively. Transmission signals, which are the up-converted radio frequency signals, are divided into four signals by the signal combiners/dividers 116A and 116B, respectively. The respective four signals pass through the resonant line 150 and corresponding signal paths, and are fed to the radiating electrodes 121 and 122 different from each other. At this time, the directivity of the antenna device 120 may be adjusted by individually adjusting a phase shift degree in the phase-shifters 115A to 115H disposed in the respective signal paths. The attenuators 114A to 114H adjust magnitude of the transmission signals.

Reception signals, which are radio frequency signals received by the radiating electrodes 121 and 122, are transferred to the RFIC 110 through the resonant line 150, and are combined in the signal combiners/dividers 116A and 116B through different signal paths, respectively. The combined reception signals are down-converted by the mixers 118A and 118B, amplified by the amplification circuits 119A and 119B, and transferred to the BBIC 200, respectively.

The resonant line 150 includes resonant lines 150A to 150H. The resonant lines 150A to 150H are coupled to the switches 111A to 111H in the RFIC 110, respectively. Each of the resonant lines 150A to 150H constitutes a resonator together with a corresponding transmission path, and functions as a band-stop filter that attenuates a signal in a specific frequency band. The radio frequency signals outputted from the RFIC 110 pass through the resonant lines 150A to 150H and are supplied to the corresponding radiating electrodes 121 and 122, respectively.

More specifically, the resonant lines 150A to 150D provided in the transmission path of the radiating electrode 121 each attenuate a signal in a frequency band of a radio wave radiated from the radiating electrode 122. On the other hand, the resonant lines 150E to 150H provided in the transmission path of the radiating electrode 122 each attenuate a signal in a frequency band of a radio wave radiated from the radiating electrode 121. Accordingly, by disposing the resonant lines 150A to 150H, isolation between the radiating electrode 121 and the radiating electrode 122 may be increased. In addition, the resonant lines 150A to 150D may improve signal quality by attenuating a signal in a harmonic wave band of a radio wave radiated from the radiating electrode 121.

Although the antenna device 120 and the resonant line 150 are separately illustrated in FIG. 1, the resonant line 150 is formed inside the antenna device 120 in the present disclosure as described later.

### (Configuration of Antenna Module)

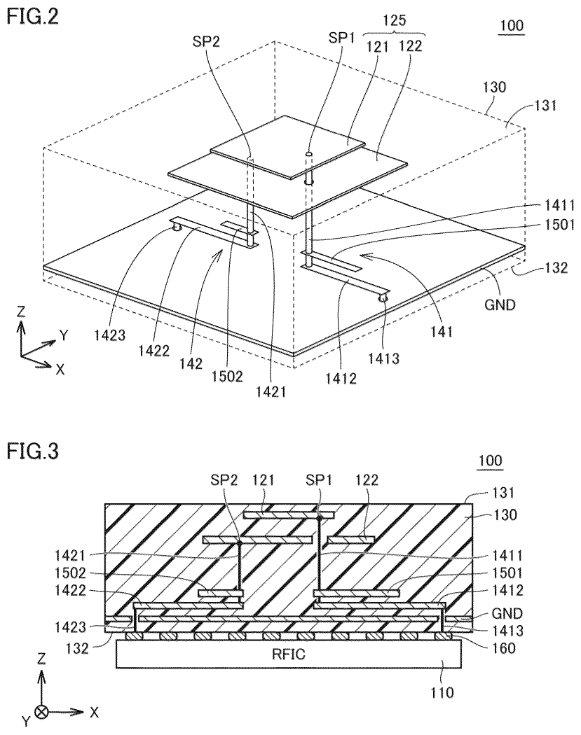

Next, a configuration of the antenna module 100 in Embodiment 1 will be described in detail with reference to FIG. 2 and FIG. 3. FIG. 2 is a perspective view of the antenna module 100. FIG. 3 is a side perspective view of the antenna module 100.

In FIG. 2 and FIG. 3, a case in which the antenna module 100 includes the single radiating element 125 (radiating electrodes 121 and 122) will be described, but the antenna module 100 may be an array antenna in which a plurality of radiating elements are disposed in a one-dimensional array or a two-dimensional array, as described in FIG. 1.

Referring to FIG. 2 and FIG. 3, the antenna module 100 includes a dielectric substrate 130, feed lines 141 and 142, and a ground electrode GND, in addition to the radiating element 125 and the RFIC 110. In FIG. 2, the dielectric substrate 130 and the RFIC 110 are omitted to facilitate explanation. In the following explanation, a normal direction (radiation direction of radio wave) of the dielectric substrate 130 is defined as a Z-axis direction, and a plane perpendicular to the Z-axis direction is determined by an X-axis and a Y-axis. In addition, a positive direction of the Z-axis in each drawing may be referred to as an upper side, and a negative direction may be referred to as a lower side.

The dielectric substrate 130 is, for example, a low temperature co-fired ceramics (LTCC) multilayer substrate, a multilayer resin substrate formed by laminating a plurality of resin layers made of resin such as epoxy or polyimide, a multilayer resin substrate formed by laminating a plurality of resin layers made of liquid crystal polymer (LCP) having a further lower dielectric constant, a multilayer resin substrate formed by laminating a plurality of resin layers made of fluororesin, a multilayer resin substrate formed by laminating a plurality of resin layers made of polyethylene terephthalate (PET) material, or a ceramic multilayer substrate other than LTCC. The dielectric substrate 130 does not necessarily have a multilayer structure, and may be a single-layer substrate.

The dielectric substrate 130 has a substantially rectangular parallelepiped shape, and the radiating electrode 121 is disposed on an upper surface 131 (surface in positive direction of Z-axis) or in an internal dielectric layer near the upper surface 131. The radiating electrode 121 may be disposed so as to be exposed on a surface of the dielectric substrate 130, or may be disposed in an internal dielectric layer of the dielectric substrate 130 as illustrated in FIG. 3.

A radiating electrode 122 is disposed in a dielectric layer on a side of a lower surface 132 relative to the radiating electrode 121 so as to face the radiating electrode 121. A ground electrode GND is disposed over the entire dielectric layer near the lower surface 132 of the dielectric substrate 130 to face the radiating electrodes 121 and 122. The radiating electrodes 121 and 122 and the ground electrode GND overlap with each other in plan view from the normal direction (Z-axis direction) of the dielectric substrate 130. That is, the radiating electrode 122 is disposed between the radiating electrode 121 and the ground electrode GND.

Each of the radiating electrodes 121 and 122 is a flat planar shaped electrode having a rectangular shape. A size of the radiating electrode 121 is smaller than a size of the radiating electrode 122, and a resonant frequency of the radiating electrode 121 is higher than a resonant frequency of the radiating electrode 122. Because of that, a frequency band of a radio wave radiated from the radiating electrode 121 is higher than a frequency band of a radio wave radiated from the radiating electrode 122. That is, the antenna module 100 is a dual-band type antenna module, having a stack structure, which can radiate radio waves in two frequency bands different from each other. Note that, in the example of Embodiment 1, the frequencies of the radio waves radiated from the radiating electrodes 121 and 122 are 39 GHz and 28 GHZ, respectively.

The RFIC 110 is mounted on the lower surface 132 of the dielectric substrate 130 through a solder bump 160. Note that the RFIC 110 may be coupled to the dielectric substrate 130 using a multielectrode coupler instead of solder coupling.

Radio frequency signals are supplied from the RFIC 110 to the radiating electrodes 121 and 122 through the feed lines 141 and 142, respectively. The feed line 141 extends from the RFIC 110, penetrates through the ground electrode GND and the radiating electrode 122, and is coupled to a feed point SP1 of the radiating electrode 121. The feed line 142 extends from the RFIC 110, penetrates through the ground electrode GND, and is coupled to the feed point SP2 of the radiating electrode 122. The feed point SP1 is offset from a center of the radiating electrode 121 in a positive direction of the X-axis, and the feed point SP2 is offset from a center of the radiating electrode 122 in a negative direction of the X-axis. Thus, each of the radiating electrodes 121 and 122 radiates a radio wave whose polarization direction is the X-axis direction.

The feed line 141 includes vias 1411 and 1413 and a strip-shaped planar electrode 1412. The via 1413 extends from the solder bump 160 to couple the RFIC 110 and penetrates through the ground electrode GND, and is coupled to one end of the planar electrode 1412 disposed in a dielectric layer on a side of the upper surface 131 relative to the ground electrode GND. The planar electrode 1412 extends to a position below the feed point SP1 of the radiating electrode 121. The via 1411 is coupled to the other end of the planar electrode 1412 and the feed point SP1 of the radiating electrode 121.

The resonant line 1501 is disposed to the via 1411. The resonant line 1501 is a strip-shaped planar electrode, and one end thereof is coupled to the via 1411. The other end of the resonant line 1501 is an open end. The resonant line 1501 extends above the planar electrode 1412 of the feed line 141, and extends along the planar electrode 1412. In other words, the planar electrode 1412 is disposed between the resonant line 1501 and the ground electrode GND.

A length of the resonant line 1501 is set to approximately λ_{g2}/4, assuming a wavelength of a radio wave in the dielectric substrate 130 radiated from the radiating electrode 122 is denoted as λ_{g2}. In other words, the length of the resonant line 1501 is set to ½ of a length of one side of the radiating electrode 122 having a square shape. With the configuration above, the resonant line 1501 and the planar electrode 1412 being a main line form a resonator having a resonant frequency that is the frequency of a radio wave radiated from the radiating electrode 122. The resonant line 1501 is coupled to the planar electrode 1412 at the open end, and a signal, in the radio frequency signal flowing through the planar electrode 1412, of the same frequency component as the resonant frequency of the resonant line 1501 is canceled and removed. That is, the resonator constituted of the resonant line 1501 and the planar electrode 1412 functions as a band-stop filter that attenuates a signal of the frequency of a radio wave radiated from the radiating electrode 122.

In the same way, the feed line 142 includes vias 1421 and 1423 and a strip-shaped planar electrode 1422. The via 1423 extends from the solder bump 160 to couple the RFIC 110 and penetrates through the ground electrode GND, and is coupled to one end of the planar electrode 1422 disposed in a dielectric layer on a side of the upper surface 131 relative to the ground electrode GND. The planar electrode 1422 extends to a position below the feed point SP2 of the radiating electrode 122. The via 1421 is coupled to the other end of the planar electrode 1422 and the feed point SP2 of the radiating electrode 122.

The resonant line 1502 is disposed to the via 1421. The resonant line 1502 is a strip-shaped planar electrode, and one end thereof is coupled to the via 1421. The other end of the resonant line 1502 is an open end. The resonant line 1502 extends above the planar electrode 1422 of the feed line 142, and extends along the planar electrode 1422. In other words, the planar electrode 1422 is disposed between the resonant line 1502 and the ground electrode GND.

A length of the resonant line 1502 is set to approximately λ_{g1}/4, assuming a wavelength of a radio wave in the dielectric substrate 130 radiated from the radiating electrode 121 is denoted as λ_{g1}. In other words, the length of the resonant line 1502 is set to ½ of a length of one side of the radiating electrode 121 having a square shape. With the configuration above, the resonant line 1502 and the planar electrode 1422 being a main line form a resonator having a resonant frequency that is the frequency of a radio wave radiated from the radiating electrode 121. The resonant line 1502 is coupled to the planar electrode 1422 at the open end, and a signal, in the radio frequency signal flowing through the planar electrode 1422, of the same frequency component as the resonant frequency of the resonant line 1502 is canceled and removed. That is, the resonator constituted of the resonant line 1502 and the planar electrode 1422 functions as a band-stop filter that attenuates a signal of the frequency of a radio wave radiated from the radiating electrode 121.

### (Bandpass Characteristic of Transmission Line)

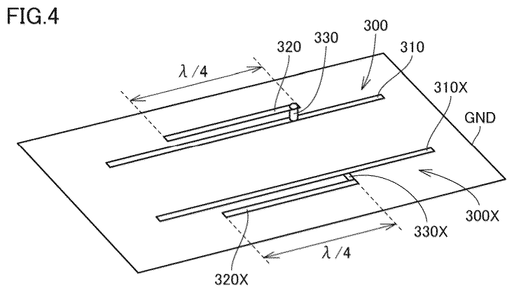

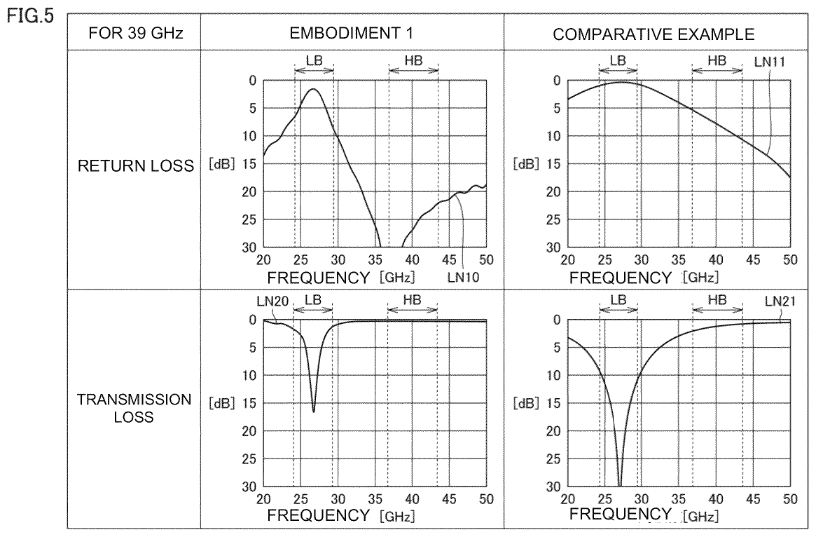

Next, characteristics of the transmission line used in the antenna module 100 will be described together with a comparative example with reference to FIG. 4 to FIG. 6.

FIG. 4 is a perspective view for explaining a configuration of a transmission line 300 corresponding to the feed lines 141 and 142 illustrated in FIG. 2 and a configuration of a transmission line 300X of the comparative example. The transmission line 300 includes a main line 310 separately disposed from the ground electrode GND, a resonant line 320, and a via 330. The resonant line 320 is disposed above the main line 310 and along the main line 310. The via 330 couples one end of the resonant line 320 and the main line 310. The main line 310 corresponds to the planar electrodes 1412 and 1422 in FIG. 2. The resonant line 320 corresponds to the resonant lines 1501 and 1502 in FIG. 2. The via 330 corresponds to the via 1411 and 1421 in FIG. 2. A length of the resonant line 320 is set to λ/4, assuming a wavelength of a radio frequency signal of the frequency to be blocked is denoted as λ.

The transmission line 300X of the comparative example includes a main line 310X separately disposed from the ground electrode GND and an open stub constituted of a line 320X and a planar electrode 330X. The line 320X is disposed along the main line 310X at a position separated from the main line 310X on the same plane as the main line 310X. The planar electrode 330X couples one end of the line 320X and the main line 310X. A length of the line 320X is also set to λ/4, assuming a wavelength of a radio frequency signal of the frequency to be blocked is denoted as λ.

FIG. 5 is a diagram illustrating a simulation result of a bandpass characteristic assuming the transmission line 300 is the feed line 141 of the radiating electrode 121 that radiates a radio wave of 39 GHz. That is, a signal in a 39 GHz band (37 to 43.5 GHZ) of a high band (HB) side is allowed to pass through, and a signal in a 28 GHz band (24.25 to 29.5 GHZ) of a low band (LB) side is blocked. Note that, in the case of FIG. 5, the lengths of the resonant line 320 of the transmission line 300 and the line 320X of the transmission line 300X each are set to ¼ of a wavelength of a signal of 28 GHZ.

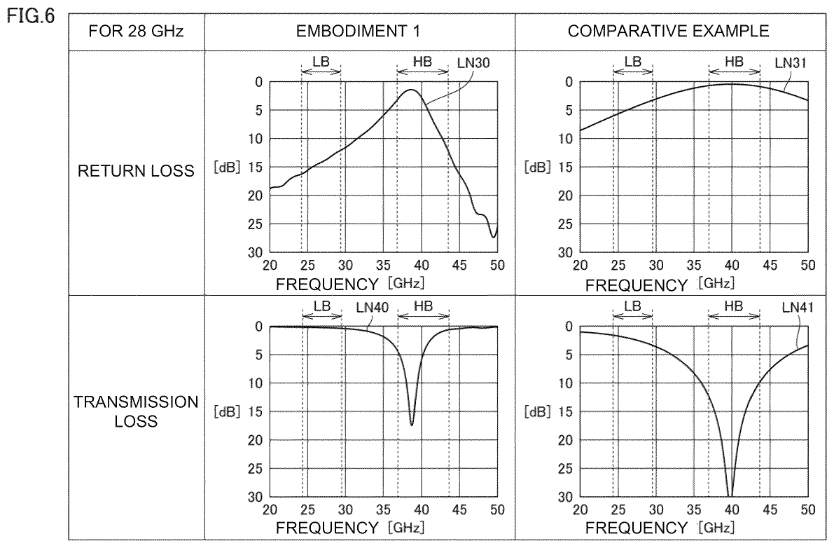

In FIG. 5 and FIG. 6 that is described later, characteristics (lines LN10 and LN20/lines LN30 and LN40) of the transmission line 300 corresponding to Embodiment 1 are illustrated in left column, and characteristics (lines LN11 and LN21/lines LN31 and LN41) of the transmission line 300X of the comparative example are illustrated in right column. Return loss is illustrated in an upper section, and transmission loss is illustrated in a lower section.

As illustrated in FIG. 5, in the transmission line 300X of the comparative example, an attenuation amount is large in the 28 GHz band to be attenuated, and the attenuation occurs over a wide band. However, the effect of attenuation also occurs in a range of the 39 GHz band being a pass band of the HB side, and a loss of 5 to 11 dB occurs in the return loss (line LN11), and a loss of 2 to 3 dB occurs in the transmission loss (line LN21).

On the other hand, in the transmission line 300 corresponding to Embodiment 1, although the attenuation amount in the 28 GHz band to be attenuated is smaller than that of the comparative example, the return loss is approximately 22 to 40 dB (line LN10) and the transmission loss is less than 1 dB (line LN20) over the entire 39 GHz band being a pass band.

FIG. 6 is a diagram illustrating a simulation result of a bandpass characteristic assuming the transmission line 300 is the feed line 142 of the radiating electrode 122 that radiates a radio wave of 28 GHz. That is, a signal in the 28 GHz band (24.25 to 29.5 GHZ) of the LB side is allowed to pass through, and a signal in the 39 GHz band (37 to 43.5 GHz) of the HB side is blocked. Note that, in the case of FIG. 6, the lengths of the resonant line 320 of the transmission line 300 and the line 320X of the transmission line 300X each are set to ¼ of a wavelength of a signal of 39 GHz.

As illustrated in FIG. 6, in the transmission line 300X of the comparative example, the attenuation amount is large in the 39 GHz band to be attenuated, and the attenuation occurs over a wide band. However, the effect of attenuation also occurs in a range of the 28 GHz band being a pass band of the LB side, and a loss of 3 to 6 dB occurs in the return loss (line LN31), and a loss of 2 to 3 dB occurs in the transmission loss (line LN41).

On the other hand, in the transmission line 300 corresponding to Embodiment 1, although the attenuation amount in the 39 GHz band to be attenuated is smaller than that of the comparative example, the return loss is approximately 12 to 17 dB (line LN30) and the transmission loss is less than 1 dB (line LN40) over the entire 28 GHZ band being a pass band.

Thus, like the transmission line 300, by using a resonator constituted of the resonant line 320 disposed in a different layer, the resonator may be configured with a small disposition area. Further, the attenuation amount of a frequency band to be attenuated may be secured while suppressing the effect on a pass band. In other words, the frequency band to be attenuated may be attenuated in a narrow band.

The reason why the characteristic above is obtained is considered as follows. Since the main line 310 is disposed between the resonant line 320 and the ground electrode GND, the main line 310 functions as a shield. This makes the coupling between the resonant line 320 and the ground electrode GND be weakened compared with the coupling between the line 320X and the ground electrode GND in the comparative example.

As illustrated in FIG. 5 and FIG. 6, in the configuration of the transmission line of Embodiment 1, the attenuation band may be narrowed, but the absolute value of the attenuation amount is smaller than that of the configuration of the comparative example. Because of that, in a situation that a large attenuation amount is required, the configuration of the comparative example may be preferable compared with the configuration of Embodiment 1. Further, assuming an interval between two pass bands is large and the attenuation effect on one pass band does not affect the other pass band so much, using the configuration of the comparative example may generate no problem in use. Accordingly, which configuration is adopted between the transmission line of Embodiment 1 and the transmission line of the comparative example is appropriately selected from specifications such as the frequency band of a signal allowed to pass through and to be attenuated, a required attenuation level, and the like.

### (Effect of Distance Between Main Line and Resonant Line)

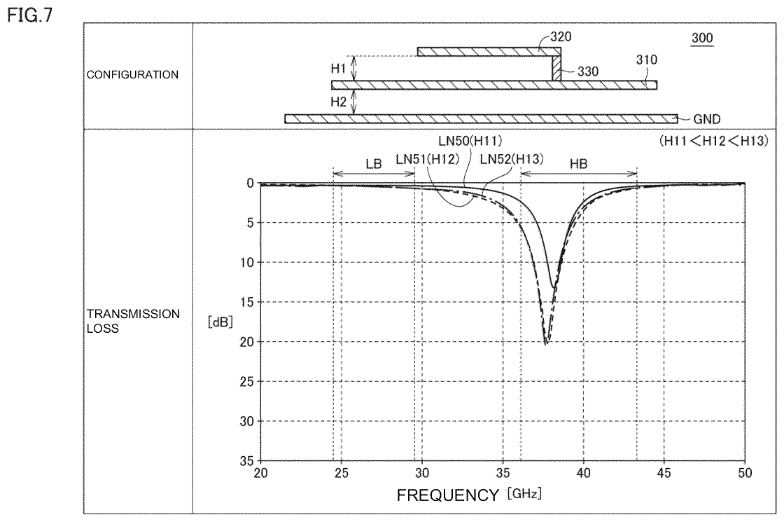

An effect of the distance between the main line 310 and the resonant line 320 on the bandpass characteristic will be described with reference to FIG. 7. In FIG. 7, a side view of the transmission line 300 in FIG. 4 is illustrated in an upper section, and a simulation result of a transmission loss assuming a distance H1 between the main line 310 and the resonant line 320 is varied is illustrated in a lower section. In FIG. 7, the transmission loss assuming the transmission line 300 is used as the feed line 142 of the LB side (that is, in a case of a feed line for 28 GHz) is the target. A solid line LN50 indicates a case that the distance H1 is H11, a broken line LN51 indicates a case that the distance H1 is H12, and a dashed-and-dotted line LN52 indicates a case that the distance H1 is H13. Note that, among three examples, the distance H11 is the closest and the distance H13 is the farthest (H11<H12<H13).

As illustrated in FIG. 7, as the distance H1 between the main line 310 and the resonant line 320 increases, the attenuation amount in the 39 GHz band gradually increases, and the attenuation range also expands. In other words, the attenuation range is narrowed as the resonant line 320 approaches the main line 310. Assuming the resonant line 320 becomes far from the main line 310, a shielding effect by the main line 310 decreases, and a capacitive coupling between the resonant line 320 and the ground electrode GND becomes strong. This makes characteristic impedance of the transmission line increase, and as a result, the band width of the attenuation range becomes wider and the attenuation amount as well becomes larger.

Cases follows in which the distance H1 between the main line 310 and the resonant line 320 is fixed and a distance H2 between the ground electrode GND and the main line 310 is varied. Assuming the distance H2 is increased, the attenuation range becomes narrower because the capacitive coupling between the resonant line 320 and the ground electrode GND becomes weaker. Conversely, assuming the distance H2 is decreased, since the capacitive coupling between the ground electrode GND and the resonant line 320 becomes stronger, the attenuation range becomes wider.

Accordingly, by adjusting the distance between the main line 310 and the ground electrode GND and/or the distance between the main line 310 and the resonant line 320, the attenuation amount and the band width in the target frequency range may be adjusted.

### (Effect of Line Width of Resonant Line)

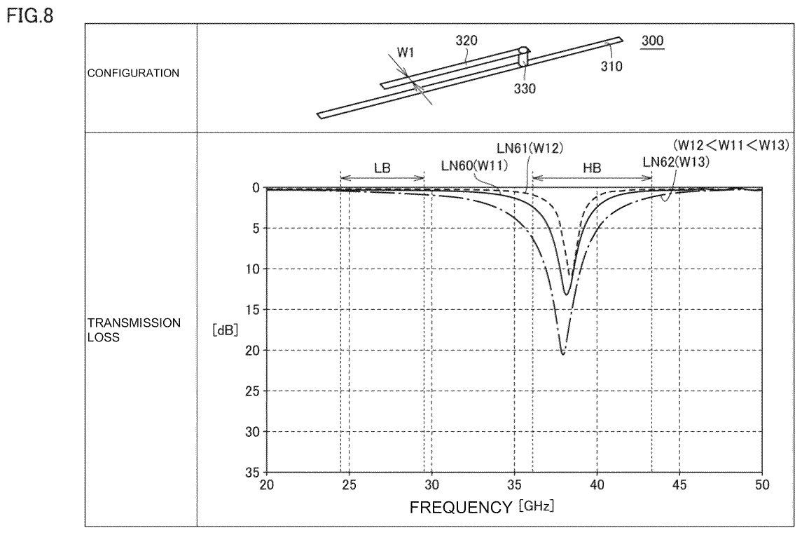

Next, an effect of a line width of the resonant line 320 on the bandpass characteristic will be described with reference to FIG. 8. In FIG. 8 as well, the transmission loss is targeted assuming the transmission line 300 is used as the feed line 142 of the LB side (that is, in a case of a feed line for 28 GHZ). A solid line LN60 indicates a case that a line width W1 of the resonant line 320 is the same as that of the main line 310 (W11), a broken line LN61 indicates a case that the line width W1 of the resonant line 320 is narrower than that of the main line 310 (W12), and a dashed-and-dotted line LN62 indicates a case that the line width W1 of the resonant line 320 is wider than that of the main line 310 (W13). That is, W12<W11<W13 holds.

As illustrated in FIG. 8, assuming the line width W1 of the resonant line 320 becomes narrower than that of the main line 310, the attenuation amount and the band width in the target frequency range each become smaller, and assuming the line width W1 of the resonant line 320 becomes wider than that of the main line 310, the attenuation amount and the band width in the target frequency range each become larger.

Assuming the line width W1 of the resonant line 320 is narrower than that of the main line 310, since the shielding effect of the main line 310 increases, the capacitive coupling between the resonant line 320 and the ground electrode GND becomes weak. This results in an attenuation characteristic with a narrow band width. On the other hand, assuming the line width W1 of the resonant line 320 is wider than that of the main line 310, the capacitive coupling with the ground electrode GND becomes strong with a portion protruding from the main line 310. This results in an attenuation characteristic with a wide band width. Thus, the attenuation amount and the band width in the target frequency range may be adjusted by adjusting the line width of the resonant line 320.

Each of the “planar electrodes 1412 and 1422” and the “main line 310” in Embodiment 1 corresponds to a “first line” in the present disclosure. Each of the “resonant lines 1501 and 1502” and the “resonant line 320” in Embodiment 1 corresponds to a “second line” in the present disclosure. Each of the “vias 1411 and 1421” in Embodiment 1 corresponds to a “first coupling electrode” or a “first via” in the present disclosure. The “via 330” in Embodiment 1 corresponds to the “first coupling electrode” in the present disclosure. The “radiating electrode 121” and the “radiating electrode 122” in Embodiment 1 correspond to a “first radiating electrode” and a “second radiating electrode” in the present disclosure, respectively. The “feed line 141” and the “feed line 142” in Embodiment 1 correspond to a “first feed line” and a “second feed line” in the present disclosure, respectively.

### (Modification)

An example has been described in which the resonant line of the transmission line in Embodiment 1 above is configured of a λ/4 resonator having one end coupled to the main line. In Modification, an example will be described in which the resonant line is configured of a λ/2 resonator.

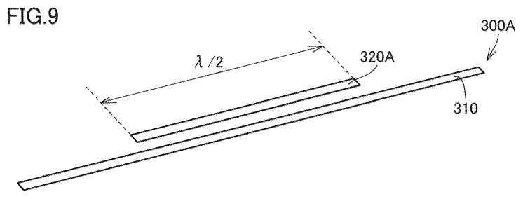

FIG. 9 is a perspective view illustrating a transmission line 300A of Modification. The transmission line 300A includes the main line 310 separately disposed from the ground electrode GND and a resonant line 320A. A radio frequency signal is supplied to the main line 310. The resonant line 320A is disposed above the main line 310 and along the main line 310. Both ends of the resonant line 320A are open ends. Assuming a wavelength of a radio frequency signal of a frequency to be blocked is denoted as λ, a length of the resonant line 320A is set to λ/2. This makes the resonant line 320A function as a λ/2 resonator whose resonant frequency is the frequency to be blocked.

Thus, as in Embodiment 1, the resonator constituted of the resonant line 320A functions as a band-stop filter that attenuates a signal component of the target frequency band, in a radio frequency signal passing through the main line 310.

Note that the “resonant line 320A” in Modification corresponds to the “second line” in the present disclosure.

### Embodiment 2

In Embodiment 2, a configuration will be described in which a plurality of resonant lines having slightly different line lengths are disposed to a main line.

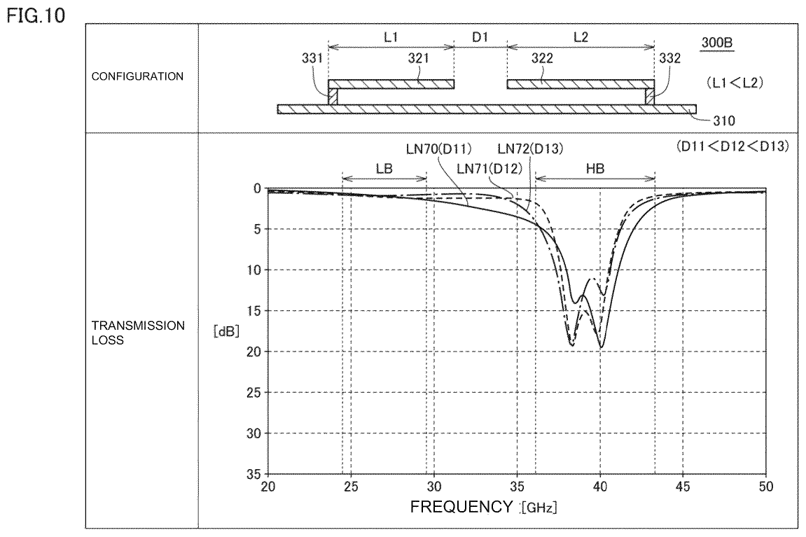

FIG. 10 is a diagram illustrating a configuration and a bandpass characteristic of a transmission line 300B according to Embodiment 2. In FIG. 10, in the same way as in FIG. 7 and FIG. 8, a side view of the transmission line 300B is illustrated in an upper section, and a simulation result of a transmission loss is illustrated in a lower section. In FIG. 10 as well, the transmission loss assuming the transmission line 300B is used as the feed line 142 of the LB side (that is, in a case of a feed line for 28 GHZ) is the target.

Referring to FIG. 10, the transmission line 300B includes a main line 310, resonant lines 321 and 322, and vias 331 and 332.

Each of the resonant line 321 and the resonant line 322 extends in the same dielectric layer above the main line 310, and extends along the main line 310. A line length of the resonant line 321 is L1, and a line length of the resonant line 322 is L2 which is slightly longer than the resonant line 321 (L1<L2). One end of the resonant line 321 is coupled to the main line 310 with the via 331, and the other end is an open end. In the same way, one end of the resonant line 322 is coupled to the main line 310 with the via 332, and the other end is an open end. Note that, in the example of FIG. 10, the resonant line 321 and the resonant line 322 are disposed such that the open ends thereof face each other. An interval between the open ends of the resonant line 321 and the resonant line 322 is D1.

With the configuration above, the resonant line 321 functions as a resonator of which resonant frequency is a frequency of a radio frequency signal, the frequency in which the length L1 is ¼ of the wavelength thereof. In the same way, the resonant line 322 functions as a resonator of which resonant frequency is a frequency of a radio frequency signal, the frequency in which the length L2 is ¼ of the wavelength thereof. In the transmission line 300B, each of attenuation poles at two different frequencies is formed by each of the resonant line 321 and the resonant line 322, as indicated by lines LN70, LN71, and LN72 in the lower section of FIG. 10. By adjusting the frequency at which the attenuation pole is formed, that is, by adjusting the length of each resonant line, an attenuation band width in a frequency band to be attenuated may be adjusted.

A change in the attenuation characteristic, assuming the interval D1 between the resonant line 321 and the resonant line 322 is varied, is illustrated in a graph of the bandpass characteristic in the lower section. In the graph of the lower section, the solid line LN70 indicates a case that the interval D1 is D11, the broken line LN71 indicates a case that the interval D1 is D12, and the dashed-and-dotted line LN72 indicates a case that the interval D1 is D13. Note that, among the three examples, the interval D11 is the narrowest and the interval D13 is the widest (D11<D12<D13).

As illustrated in FIG. 10, assuming the interval between the two resonant lines becomes narrower (solid line LN70), the attenuation amount on a high frequency side increases, and the attenuation amount on a low frequency side decreases. Conversely, assuming the interval between the two resonant lines becomes wider (dashed-and-dotted line LN72), the attenuation amount on a high frequency side decreases, and the attenuation amount on a low frequency side increases. In the example of FIG. 10, assuming the interval between the two resonant lines is narrow (solid line LN70), an effect of the attenuation on the LB side is larger than in other cases.

By adjusting the length of each resonant line (that is, frequency of attenuation pole) and the interval between the resonant lines, a band width and an attenuation amount of an attenuation range and an extent of an effect on other pass bands may appropriately be adjusted.

Note that, although the configuration is illustrated in FIG. 10 in which the two resonant lines are disposed such that the open ends thereof face each other, the two resonant lines may be disposed such that the coupling ends to the main line face each other. Alternatively, the two resonant lines may be disposed such that the open end of one resonant line and the coupling end of the other resonant line face each other. Furthermore, three or more resonant lines may be disposed on the main line.

The “resonant line 321” and the “resonant line 322” in Embodiment 2 correspond to the “second line” and a “third line” in the present disclosure, respectively. The “via 331” and the “via 332” in Embodiment 2 correspond to the “first coupling electrode” and a “second coupling electrode” in the present disclosure, respectively.

### Embodiment 3

In Embodiment 3, a configuration will be described in which a line width of a resonant line changes on the way in an extending direction of the resonant line.

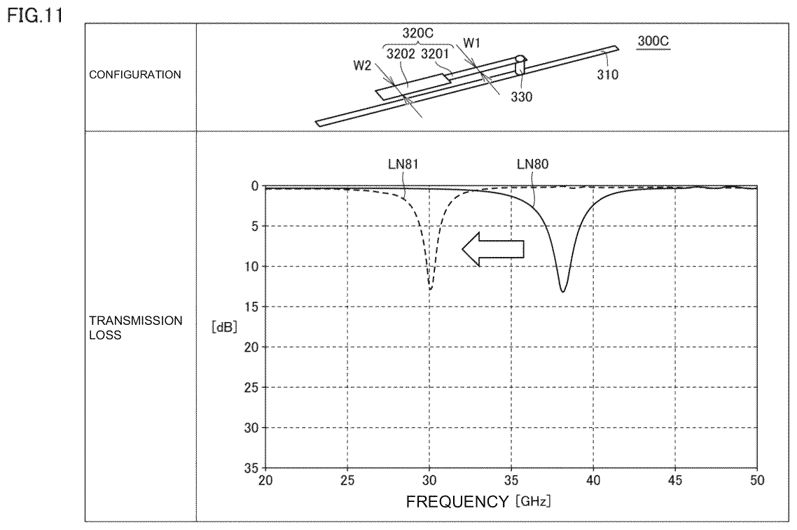

FIG. 11 is a diagram illustrating a configuration and a bandpass characteristic of a transmission line 300C according to Embodiment 3. In FIG. 11, in the same way as in FIG. 10, a perspective view of the transmission line 300C is illustrated in an upper section, and a simulation result of the transmission loss is illustrated in a lower section. In FIG. 11 as well, the transmission loss assuming the transmission line 300C is used as the feed line 142 of the LB side (that is, in a case of a feed line for 28 GHZ) is the target.

Referring to FIG. 11, the transmission line 300C includes the main line 310, a resonant line 320C, and the via 330. The resonant line 320C includes a first region 3201 having a line width of W1 and a second region 3202 having a line width of W2 wider than W1 (W1<W2), and extends above the main line 310 and along the main line 310. One end of the first region 3201 is coupled to the main line 310 through the via 330. The other end of the first region 3201 is coupled to one end of the second region 3202, and the other end of the second region 3202 is an open end.

In a line having one end being an open end and the other end being coupled, electric field at a side of the open end tends to be stronger than that at a side of the coupled end in many cases. Because of that, capacitive property is relatively strong at the side of the open end, and inductive property is relatively strong at the side of the coupled end. Assuming the entire line width of the resonant line above is widened, a capacitance value on the side of the open end increases, but an inductance value on the side of the coupled end decreases, and as a result, the resonant frequency of the resonant line does not change. Conversely, assuming the line width of the entire resonant line is narrowed, the capacitance value on the side of the open end decreases, but the inductance value on the side of the coupled end increases, and thus the resonant frequency of the resonant line does not change in this case as well.

However, assuming the line width W2 on the side of the open end is made wider than the line width W1 on the side of the coupled end as in the resonant line 320C, the capacitance value on the side of the open end increases, but the inductance value on the side of the coupled end does not change. Thus, the resonant frequency of the resonant line lowers from the relationship of f=1/{2π(LC)^{1/2}} assuming the line length is the same. Assuming the line width on the side of the coupled end is narrowed without changing the line width on the side of the open end as well, the capacitance value on the side of the open end does not change. However, since the inductance value on the side of the coupled end increases, the resonant frequency of the resonant line lowers in the same way.

In the graph of the bandpass characteristic in the lower section, a solid line LN80 indicates an attenuation characteristic assuming a resonant line has a uniform line width, and a broken line LN81 indicates an attenuation characteristic of the resonant line 320C in Embodiment 3. As illustrated in the graph, the attenuation amount and the attenuation band width are substantially constant, but a frequency at which an attenuation pole occurs lowers in the case of the resonant line 320C.

As described above, in a resonant line having one end being an open end, a frequency at which an attenuation pole occurs may be lowered while maintaining the characteristics of the attenuation amount and the attenuation band width, by making the line width on the side of the open end wider than the line width on the side of the coupled end without changing the line length. Conversely, assuming the frequency at which the attenuation pole occurs is the same, the line length of the resonant line may be shortened, and thus, the size may be reduced with the same attenuation characteristic.

In a case of a resonant line formed of a ½ wavelength resonator having both ends being open ends as illustrated in Modification of FIG. 9, by making the line width of each of both open ends wider than the line width of a center portion of the resonant line in an extending direction, the same effect as that of the resonant line 320C of Embodiment 3 may be obtained.

### [Modification of Antenna Module]

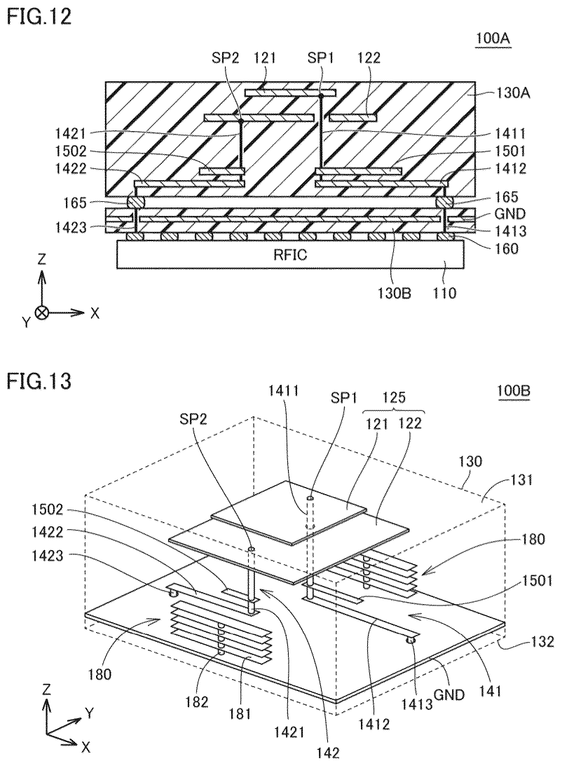

Next, Modification of the antenna module will be described with reference to FIG. 12 and FIG. 13.

### First Example

FIG. 12 is a side transparent view illustrating a first modification of the antenna module. In the antenna module 100A illustrated in FIG. 12, a dielectric substrate 130B in which the ground electrode GND is disposed is separated from a dielectric substrate 130A in which the radiating element 125 and the resonant lines 1501 and 1502 are formed. The vias 1413 and 1423 of the feed lines 141 and 142 each are coupled with a solder bump 165 between the dielectric substrates 130A and 130B.

Even in an antenna module described above to which the ground electrode GND is separately disposed, by disposing a resonant line above a planar electrode of a feed line along the planar electrode, a signal in a frequency band to be attenuated may be attenuated in a narrow band with a small disposition area.

The “dielectric substrates 130A and 130B” in a first example correspond to a “first substrate” and a “second substrate” in the present disclosure, respectively.

### Second Example

FIG. 13 is a perspective view illustrating a second modification of the antenna module. In an antenna module 100B of FIG. 13, a size of the dielectric substrate 130 in the Y-axis direction is reduced as compared with the antenna module 100 of Embodiment 1 illustrated in FIG. 2. The feed point SP1 of the radiating electrode 121 is disposed at a position offset from the center of the radiating electrode 121 in a positive direction of the Y-axis, and the feed point SP2 of the radiating electrode 122 is disposed at a position offset from the center of the radiating electrode 122 in a negative direction of the Y-axis. That is, the radiating electrode 121 and 122 each radiate a radio wave whose polarization direction is the Y-axis direction.

Assuming the area of the ground electrode GND in the polarization direction is limited as described above, the lines of electric force from the radiating electrode 122 of a low frequency side are generated so as to go around to a side of a rear surface of the ground electrode GND. This may degrade an antenna characteristic of a radio wave whose polarization direction is the Y-axis direction.

Because of that, in the antenna module 100B, a peripheral electrode 180 is disposed near each end portion of the ground electrode GND in the positive and negative directions of the Y-axis. The peripheral electrode 180 includes a plurality of planar electrodes 181 extending in the X-axis direction and stacked in the Z-axis direction, and at least one via 182 to couple the planar electrodes 181 and the ground electrode GND. By disposing the peripheral electrode 180 described above, since lines of electric force are preferentially generated between the radiating electrode 122 and the peripheral electrode 180, it is possible to suppress that the lines of electric force go around to the rear surface of the ground electrode GND. As a result, deterioration of the antenna characteristic of a radio wave whose polarization direction is the Y-axis direction may be suppressed.

In a case of the configuration described above, assuming the planar electrodes 1412 and 1422 of the feed lines 141 and 142 each extend in the Y-axis direction, the distance between each of the resonant lines 1501 and 1502 and the peripheral electrode decreases to make the coupling easy. This may affect the resonant frequencies of the resonant lines 1501 and 1502. In the case above, the frequency of the attenuation pole generated by a resonant circuit varies, and no desired attenuation characteristic may be obtained.

Because of that, in the antenna module 100B, the planar electrodes 1412 and 1422 of the feed lines 141 and 142 are disposed so as to extend in the X-axis direction, and as a consequence, the resonant lines 1501 and 1502 as well are disposed so as to extend in the X-axis direction. That is, the resonant lines 1501 and 1502 each extend from the via 1411 and 1421 in a direction not approaching the peripheral electrode 180. With the configuration described above, the effect of the resonant lines 1501 and 1502 on the resonant frequency may be suppressed.

### [Aspects]

(Item 1) A transmission line according to an aspect relates to a transmission line to transfer a radio frequency signal. The transmission line includes a ground electrode, a first line, and a second line. The first line is disposed to face the ground electrode and constitutes a microstrip line together with the ground electrode. The second line faces the first line and is disposed along the first line. The second line constitutes a resonator for the first line. The first line is disposed between the second line and the ground electrode.
(Item 2) In the transmission line described in Item 1, a distance between the first line and the ground electrode is larger than a distance between the first line and the second line.
(Item 3) In the transmission line described in Item 1, a distance between the first line and the second line is larger than a distance between the first line and the ground electrode.
(Item 4) In the transmission line described in any one of Item 1 to Item 3, a line width of the first line is larger than a line width of the second line.
(Item 5) In the transmission line described in any one of Item 1 to Item 3, a line width of the second line is larger than a line width of the first line.
(Item 6) The transmission line described in any one of Item 1 to Item 5 further includes a first coupling electrode to couple a first end of the second line and the first line. A second end of the second line is an open end. Assuming a wavelength of a radio frequency signal to be blocked in the first line is denoted as λ, a length of the second line is set to a length of λ/4.
(Item 7) In the transmission line described in Item 6, the second line includes a first region including the first end of the second line and a second region including the second end of the second line. A line width of the second region is larger than a line width of the first region.
(Item 8) The transmission line described in Item 6 further includes a third line that faces the first line and is disposed along the first line, and a second coupling electrode to couple a first end of the third line and the first line. In plan view from the normal direction of the ground electrode, the second line and the third line do not overlap with each other. A second end of the third line is an open end. The third line constitutes a resonator for the first line. Assuming a wavelength of a radio frequency signal to be blocked in the first line is denoted as λ, a length of the third line is set to a length of λ/4.
(Item 9) In the transmission line described in any one of Item 1 to Item 5, both ends of the second line are open ends. Assuming a wavelength of a radio frequency signal to be blocked in the first line is denoted as λ, the length of the second line is set to a length of λ/2.
(Item 10) The transmission line described in any one of Item 1 to Item 9 further includes a first substrate to which the first line and the second line are disposed, and a second substrate to which the ground electrode is disposed.
(Item 11) An antenna module according to an aspect includes a ground electrode, a first radiating electrode, a second radiating electrode, a first feed line, and a second feed line. Each of the first radiating electrode and the second radiating electrode is disposed to face the ground electrode and has a flat planar shape. The first feed line transfers a radio frequency signal to the first radiating electrode. The second feed line transfers a radio frequency signal to the second radiating electrode. The second radiating electrode is disposed between the first radiating electrode and the ground electrode. A size of the second radiating electrode is larger than a size of the first radiating electrode. Each of the first feed line and the second feed line includes a first line and a second line. The first line is disposed to face the ground electrode and constitutes a microstrip line together with the ground electrode. The second line faces the first line and is disposed along the first line. The second line constitutes a resonator for the first line. The first line is disposed between the second line and the ground electrode.
(Item 12) In the antenna module described in Item 11, each of the first feed line and the second feed line further includes a first via to couple the corresponding radiating electrode and the first line. In each of the first feed line and the second feed line, a first end of the second line is coupled to the first via, and a second end of the second line is an open end. Assuming a wavelength of a radio wave radiated from the first radiating electrode is denoted as λ₁ and a wavelength of a radio wave radiated from the second radiating electrode is denoted as λ₂, the second line of the first feed line is set to a length of λ₂/4, and the second line of the second feed line is set to a length of λ₁/4.
(Item 13) The antenna module described in Item 12 further includes a peripheral electrode electrically coupled to the ground electrode and extending in a first direction heading toward the first radiating electrode from the ground electrode. In each of the first feed line and the second feed line, the first line and the second line each extend from the first via toward a direction not approaching the peripheral electrode.
(Item 14) The antenna module described in any one of Item 11 to Item 13 further includes a feed circuit configured to supply a radio frequency signal to the first radiating electrode and the second radiating electrode.
(Item 15) A communication device according to an aspect includes the antenna module described in any one of Item 11 to Item 14.

The embodiments disclosed herein are to be considered in all respects as illustrative and not restrictive. The scope of the present disclosure is defined by the appended claims rather than the above description of the embodiments, and is intended to include all modifications within the scope and meaning equivalent to the appended claims.

### REFERENCE SIGNS LIST

10 COMMUNICATION DEVICE
100, 100A, 100B ANTENNA MODULE
110 RFIC
111A to 111H, 113A to 113H, 117A, 117B SWITCH
112AR to 112HR LOW-NOISE AMPLIFIER
112AT to 112HT POWER AMPLIFIER
114A to 114H ATTENUATOR
115A to 115H PHASE-SHIFTER
116A, 116B SIGNAL COMBINER/DIVIDER
118A, 118B MIXER
119A, 119B AMPLIFICATION CIRCUIT
120 ANTENNA DEVICE
121, 122 RADIATING ELECTRODE
125 RADIATING ELEMENT
130, 130A, 130B DIELECTRIC SUBSTRATE
131 UPPER SURFACE
132 LOWER SURFACE
141, 142 FEED LINE
150, 150A to 150H, 320A, 320 to 322, 320C, 1501, 1502 RESONANT LINE
160, 165 SOLDER BUMP
180 PERIPHERAL ELECTRODE
181, 330X, 1412, 1422 PLANAR ELECTRODE
182, 330 to 332, 1411, 1413, 1421, 1423 VIA
200 BBIC
300, 300A to 300C, 300X TRANSMISSION LINE
310, 310X MAIN LINE
320X LINE
3201 FIRST REGION
3202 SECOND REGION
GND GROUND ELECTRODE
SP1, SP2 FEED POINT

1. A transmission line configured to transfer a radio frequency signal, the transmission line comprising:
a ground electrode;
a first line disposed to face the ground electrode and constituting a microstrip line together with the ground electrode; and
a second line facing the first line and disposed along the first line,
wherein the second line constitutes a resonator for the first line, and
the first line is disposed between the second line and the ground electrode.

2. The transmission line according to claim 1,
wherein a distance between the first line and the ground electrode is larger than a distance between the first line and the second line.

3. The transmission line according to claim 1,
wherein a distance between the first line and the second line is larger than a distance between the first line and the ground electrode.

4. The transmission line according to claim 3,
wherein a line width of the first line is larger than a line width of the second line.

5. The transmission line according to claim 3,
wherein a line width of the second line is larger than a line width of the first line.

6. The transmission line according to claim 5, further comprising:
a first coupling electrode configured to couple a first end of the second line and the first line,
wherein a second end of the second line is an open end, and
assuming a wavelength of a radio frequency signal to be blocked in the first line is denoted as λ, a length of the second line is set to a length of λ/4.

7. The transmission line according to claim 6,
wherein the second line includes
a first region including the first end of the second line, and
a second region including the second end of the second line, and
a line width of the second region is larger than a line width of the first region.

8. The transmission line according to claim 6, further comprising:
a third line facing the first line and disposed along the first line; and
a second coupling electrode configured to couple a first end of the third line and the first line,
wherein the second line and the third line do not overlap with each other in plan view from a normal direction of the ground electrode,
a second end of the third line is an open end,
the third line constitutes a resonator for the first line, and
assuming a wavelength of a radio frequency signal to be blocked in the first line is denoted as λ, a length of the third line is set to a length of λ/4.

9. The transmission line according to claim 5,
wherein both ends of the second line are open ends, and
assuming a wavelength of a radio frequency signal to be blocked in the first line is denoted as λ, a length of the second line is set to a length of λ/2.

10. The transmission line according to claim 9, further comprising:
a first substrate to which the first line and the second line are disposed; and
a second substrate to which the ground electrode is disposed.

11. An antenna module, comprising:
a ground electrode;
a first radiating electrode and a second radiating electrode that are disposed to face the ground electrode and each have a flat planar shape;
a first feed line configured to transfer a radio frequency signal to the first radiating electrode; and
a second feed line configured to transfer a radio frequency signal to the second radiating electrode,
wherein the second radiating electrode is disposed between the first radiating electrode and the ground electrode,
a size of the second radiating electrode is larger than a size of the first radiating electrode,
each of the first feed line and the second feed line includes
a first line disposed to face the ground electrode and constituting a microstrip line together with the ground electrode, and
a second line facing the first line and disposed along the first line,
the second line constitutes a resonator for the first line, and
the first line is disposed between the second line and the ground electrode.

12. The antenna module according to claim 11,
wherein each of the first feed line and the second feed line further includes a first via coupling a corresponding radiating electrode and the first line,
in each of the first feed line and the second feed line,
a first end of the second line is coupled to the first via, and
a second end of the second line is an open end, and
assuming a wavelength of a radio wave radiated from the first radiating electrode is denoted as λ₁, and a wavelength of a radio wave radiated from the second radiating electrode is denoted as λ₂,
the second line of the first feed line is set to a length of λ₂/4, and
the second line of the second feed line is set to a length of λ₁/4.

13. The antenna module according to claim 12, further comprising:
a peripheral electrode electrically coupled to the ground electrode and extending in a first direction heading toward the first radiating electrode from the ground electrode,
wherein in each of the first feed line and the second feed line,
the first line and the second line each extend from the first via in a direction not approaching the peripheral electrode.

14. The antenna module according to claim 13, further comprising:
a feed circuit configured to supply a radio frequency signal to the first radiating electrode and the second radiating electrode.

15. A communication device, comprising:
the antenna module according to claim 14.

16. The transmission line according to claim 1,
wherein a line width of the first line is larger than a line width of the second line.

17. The transmission line according to claim 1,
wherein a line width of the second line is larger than a line width of the first line.

18. The transmission line according to claim 1, further comprising:
a first coupling electrode configured to couple a first end of the second line and the first line,
wherein a second end of the second line is an open end, and
assuming a wavelength of a radio frequency signal to be blocked in the first line is denoted as λ, a length of the second line is set to a length of λ/4.

19. The transmission line according to claim 1,
wherein both ends of the second line are open ends, and
assuming a wavelength of a radio frequency signal to be blocked in the first line is denoted as λ, a length of the second line is set to a length of λ/2.

20. The transmission line according to claim 1, further comprising:
a first substrate to which the first line and the second line are disposed; and
a second substrate to which the ground electrode is disposed.
